(19) United States
(12) Patent Application Publication
(10) Pub. No.: US 2005/0088522 A1
(43) Pub. Date: Apr. 28, 2005

(54) Accelerometer activator for in-car video

(76) Inventor: James K. Creviston, Chanute, KS (US)

Correspondence Address: James J. Kernell;Chase Law Firm, L.C., Suite 130, 4400 College Boulevard, Overland Park, KS, 66211, US

(21) Appl. No.: 10/773,360

(22) Filed: Feb. 6, 2004

Related U.S. Application Data
(60) Provisional application No. 60/513,488, filed on Oct. 22, 2003.

(51) Int. Cl. H04N 7/18

(52) U.S. Cl. 348/148; 348/143

(57) ABSTRACT

An in-car video surveillance system for a law enforcement vehicle is automatically activated in response to a collision. The system is provided with an accelerometer having an axis of operation oriented to cause the accelerometer to be responsive to an impact, and an output signal is produced when the accelerometer senses a predetermined G force. A record command initiates operation of the video recorder of the system in response to the output signal to thereby record the incident responsible for the impact.

### CROSS REFERENCE TO RELATED APPLICATION

This application claims the benefit of a prior filed, co-pending application Ser. No. 60/513,488, filed Oct. 22, 2003, entitled ACCELEROMETER ACTIVATOR FOR IN-CAR VIDEO.

### BACKGROUND OF THE INVENTION

This invention relates to a method and apparatus for automatically activating an in-car video surveillance system in response to a predetermined G force indicative of an incident that should be captured by the video system, such as a crash or collision that occurs in the course of a law enforcement operation.

Vehicle mounted video cameras and accompanying recording equipment are widely used in law enforcement in order to make a video record of an incident or scene external to the law enforcement vehicle. For example, U.S. Pat. No. 4,949,186 to Peterson discloses a vehicle mounted system in which a video cassette recorder is housed in a vault located in the trunk of a patrol car. U.S. Pat. No. 5,677,979 to Squicciarini et al discloses a video surveillance system which integrates the outputs of a video camera, a radar unit, a wireless microphone and a remote control to produce a comprehensive video recording of an incident and accompanying data. More recently, digital video surveillance systems have been introduced which provide additional flexibility and advantages, including the ability to record on a hard drive shuttle or a DVD RAM disk. The newer systems utilizing digital media also include a history buffer that is recording at all times in order to ensure that activity occurring just prior to the activation of the system is recorded as well as post activation activity. The history buffer, being in continuous operation, ensures that the event that caused the officer to initiate operation of the recording system is included in the video record.

Incidents in law enforcement occur, however, where the law enforcement officer may not be able to activate the video recorder. Although in most systems activation is automatic whenever the emergency lights or the siren of the vehicle are activated, crashes or collisions occurring suddenly and without warning may not give the officer time to respond, or the officer may be victim of the incident and unable to respond.

### BRIEF DESCRIPTION OF THE INVENTION

The aforementioned problem is addressed by providing automatic operation of an in-car video system in response to a crash or collision. An additional activator for the video system employs one or more accelerometers that, in response to a predetermined G force, deliver an output signal to the video system to instantly place the recorder in the record mode. Two accelerometers may be employed to provide response to forces acting generally in the front-to-rear direction of movement of the vehicle, and lateral forces on the vehicle from the side as would be experienced when a vehicle is struck from the side. An impact from any direction may be sensed to activate the recorder depending upon the orientation of the accelerometer or accelerometers.

Other advantages of the invention will become apparent from the following description taken in connection with the accompanying drawings, wherein is set forth by way of illustration and example, an embodiment of the present invention.

### BRIEF DESCRIPTION OF THE DRAWINGS

FIG. 1 is a block diagram of the activator and associated video recording system.

FIG. 2 is an electrical schematic diagram of the circuitry of the activator.

FIG. 3 is a plan view of a circuit board showing major components mounted and the orientation of the two accelerometers illustrated.

### DETAILED DESCRIPTION

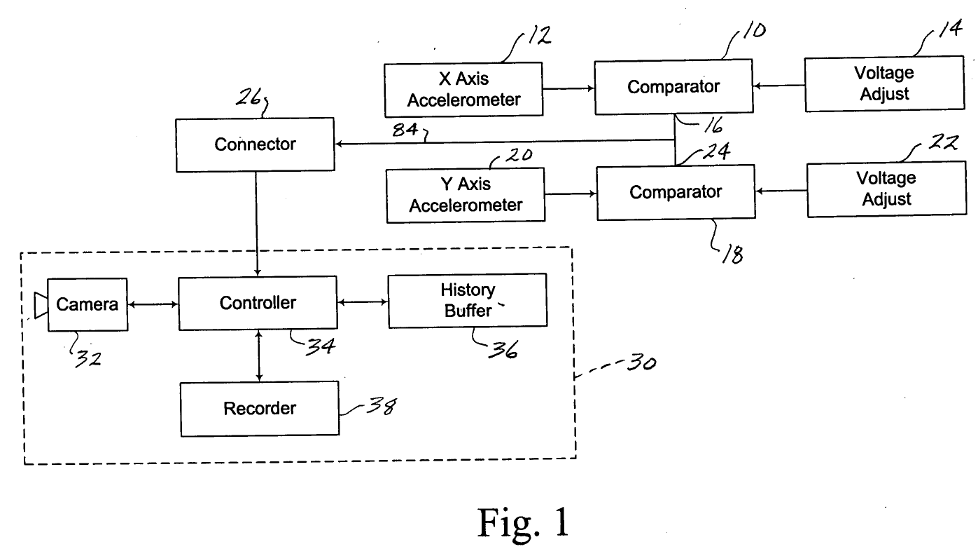

Referring to FIG. 1, in an embodiment of the invention a voltage comparator 10 is responsive to the output of an X-axis accelerometer 12 and compares this output with a preset reference voltage from a potentiometer 14, and delivers an output at 16 when the accelerometer output voltage exceeds the reference voltage. Similarly, a comparator 18 is responsive to a Y-axis accelerometer 20 and associated potentiometer 22 to deliver an output at 24 when the voltage from the accelerometer 20 exceeds the reference set by potentiometer 22. A connector 26 receives the output from either comparator 10 or 18 and interfaces the circuitry with a video recording system 30 which includes a video camera 32 and accompanying audio sources, a controller 34, a history buffer 36 for continuously receiving data from the camera 32, and a recorder 38. Typically, the camera 32 is directed forwardly through the windshield to view the scene in front of the vehicle, and may be accompanied by a second camera (not shown) pointed in a rearward direction to view the interior and occupants of the vehicle. The controller 34 is in a console (not shown) which may be mounted adjacent the rearview mirror for easy access by the driver of the vehicle. It will be appreciated that for simplicity, only those primary components of the system 30 concerned with the accelerometer activator are illustrated herein.

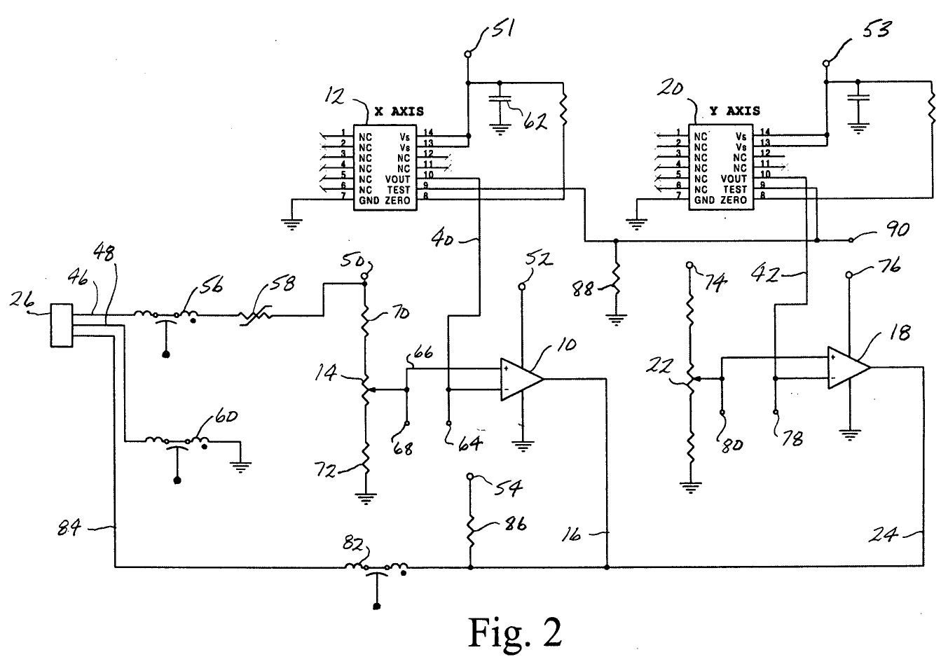

The circuitry of the activator is shown in detail in FIG. 2. Each of the accelerometers 12 and 20 shown is a single monolithic IC containing a surface-micromachined sensor and signal conditioning circuitry to implement open loop acceleration measurement architecture. The IC illustrated is an Analog Devices ADXL190 and is capable of measuring both positive and negative forces up to 100Gs. The IC contains a switched-capacitor filter and all the circuitry necessary to drive the sensor and convert the capacitance change to a voltage output. The output is ratiometric to the supply voltage so tracking will occur if the supply voltage changes. The output voltage on lead 40 or lead 42 is a function of the acceleration or G force imposed and is calibrated to be 18 millivolts per G force. Although a particular IC is described and illustrated in the embodiment shown, other accelerometer configurations responsive to the G forces produced in a collision may be employed.

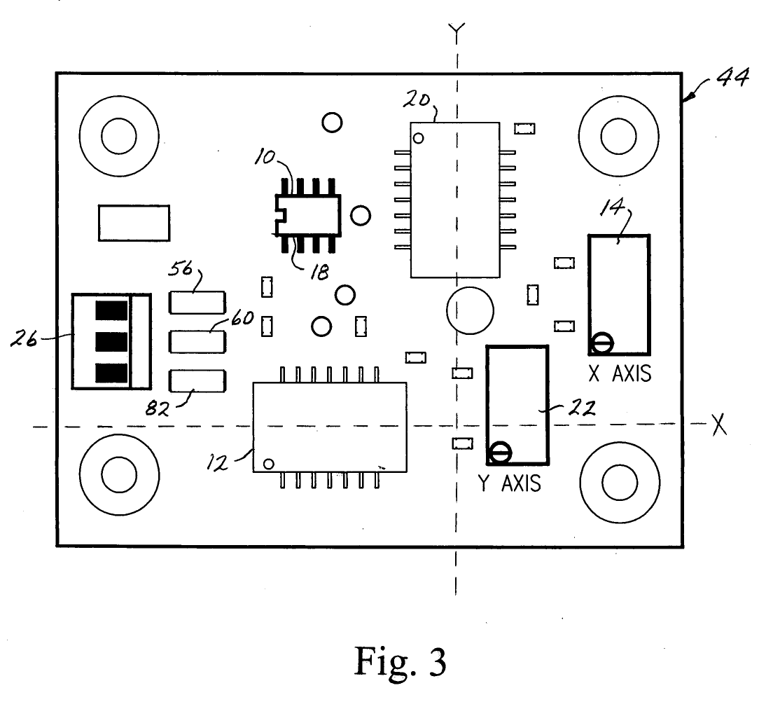

FIG. 3 shows the layout of the circuit board for the activator with X and Y axes shown in broken lines and associated with the respective accelerometer IC 12 and 20. The Y axis represents the front to rear direction of movement of the vehicle, and the X axis extends from side to side perpendicular to the Y axis. It is not required that the Y axis be on the front to rear center line of the vehicle. The circuit board 44 may be housed with the other components of the video system with the Y axis extending in a generally front to rear direction. The orientation of the axes illustrated and described herein provides high sensitivity to the expected impact forces, but other orientations of the axes may be employed if desired.

Adjustment and operation of the section of the circuitry responsive to X-axis G forces is set forth as follows, it being understood that the Y-axis accelerometer 20 operates in identical fashion. Referring to FIG. 2, leads 46 and 48 from connector 26 apply positive supply voltage (typically 5 VDC) and ground to the circuitry. Accordingly, terminals 50, 51, 52, 53, 54, 74 and 76 are at 5 volts positive (all supply connections are not shown for simplicity). An EMI filter 56 and a current limiting resistor 58 are connected in series from lead 46 to the supply terminals. Lead 48 is connected to circuit ground via EMI filter 60. Filters 58 and 60 are both shielded and the shields are connected to the chassis ground of the vehicle as schematically illustrated.

A filter capacitor 62 is connected from supply terminal 51 (pins 13 and 14 of IC 12) to ground. (The associated resistor to pin 8 is not used in this application.) The output is presented at pin 10 and is connected via lead 40 to the negative input of comparator 10 and test point 64. A lead 66 connects the positive input of comparator 10 to potentiometer 14 and a test point 68 and thus presents a preset voltage to the positive input via the voltage divider comprising series resistor chain 70, 14 and 72. Comparator 10 is an operational amplifier configured as a voltage comparator.

The circuitry associated with Y-axis accelerometer 20 and comparator 18 is identical to that as described above for X-axis accelerometer 12 and comparator 10. Positive supply voltage is at terminals 74 and 76. Test points 78 and 80 are provided. The two comparators 10 and 18 have common output leads 16 and 24 connected via an EMI filter 82 to a lead 84 from connector 26. In operation using the ADXL190 IC, potentiometer 14 is adjusted to a preset voltage of 2.68 volts at test point 68. Potentiometer 22 is adjusted to a preset voltage of 2.698 volts at test point 80. These voltage levels establish a setting for activation of the comparators 10 and 18 when the outputs from the respective accelerometers 12 and 20 exceed these voltage levels, which correspond to a G force of 10Gs. Examples of settings for higher G-force activation are:

| X AXIS | Y AXIS |
|---|---|
| 30 G = 3.04 V | 30 G = 3.058 V |
| 20 G = 2.86 V | 20 G = 2.878 V |

It is assumed for purposes of illustration that operation is desired at the 10G level, and that an impact equal to or exceeding 10Gs occurs along the X axis. When the output of accelerometer 12 exceeds the preset voltage level of 2.68 volts, comparator 10 is activated and provides a current sink to ground via a pull-up resistor 86 (such as 10,000 ohms) to EMI filter 82 and lead 84 to connector 26. The controller electronics (controller 34, FIG. 1) respond to this logic low to deliver a record command to the recorder 38 and transfer the data in the history buffer 36 to the recording medium. This initiates the record mode function to make a record of the incident in the same manner as occurs automatically in conventional systems when the siren or emergency lights are activated, or upon manual selection by the operator. The same action in the circuitry associated with accelerometer 20 occurs in response to a 10G force in the Y direction that could be caused, for example, by a frontal impact, resulting in a logic low on lead 84 to the connector 26 to which the controller 34 responds.

For test purposes to simulate a G force of 40Gs, a test point 90, common to pin 9 of both accelerometers is provided. When 5 volts is applied to test point 90 across resistor 88 (10,000 ohms, for example), the 40G force is simulated and both accelerometers will then produce a voltage at their output pins 10 (leads 40 and 42) of approximately 3.19 volts. This voltage can be measured at test points 64 and 78 to ensure each accelerometer is functioning.

1. A method of automatically activating an in-car video surveillance system in response to a collision, said method comprising the steps of:
(a) providing a law enforcement vehicle with an accelerometer having an axis of operation oriented to cause the accelerometer to be responsive to an impact,
(b) producing an output signal when said accelerometer senses a predetermined G force indicative of said impact,
(c) providing an in-car video surveillance system having a video recorder and a record mode initiated in response to a record command, and
(d) delivering said record command to said video recorder in response to said output signal, whereby the video surveillance system records the incident responsible for the impact.

2. The method as claimed in claim 1, wherein said step (c) includes providing said in-car video surveillance system with a history buffer responsive to said record command to transfer data in the buffer to the video recorder.

3. A method of automatically activating an in-car video surveillance system in response to a collision, said method comprising the steps of:
(a) providing a law enforcement vehicle with a first accelerometer having an axis of operation extending generally in the front to rear direction of movement of the vehicle,
(b) providing the vehicle with a second accelerometer having an axis of operation extending transversely of said direction of movement,
(c) producing a first output signal when said first accelerometer senses a predetermined G force indicative of an impact,
(d) producing a second output signal when said second accelerometer senses a predetermined G force indicative of an impact,
(e) providing an in-car video surveillance system having a video recorder and a record mode initiated in response to a record command, and
(f) delivering said record command to said video recorder in response to at least one of said output signals, whereby the video surveillance system records the incident responsible for the impact.

4. The method as claimed in claim 3, wherein said step (e) includes providing said in-car video surveillance system with a history buffer responsive to said record command to transfer data in the buffer to the video recorder.

5. In an in-car video surveillance system:
an accelerometer having an axis of operation and adapted to be mounted in a vehicle with said axis oriented to cause the accelerometer to be responsive to an impact,
circuitry responsive to said accelerometer for producing an output signal when said accelerometer senses a predetermined G force indicative of said impact,
a video recorder having a record mode initiated in response to a record command, and
a controller for delivering said record command to said video recorder in response to said output signal, whereby the video surveillance system records the incident responsible for the impact.

6. The combination as claimed in claim 5, further comprising a history buffer responsive to said record command for transferring data in the buffer to the video recorder.

7. The combination as claimed in claim 5, wherein said circuitry includes a comparator responsive to said accelerometer for delivering said output signal when an output voltage from said accelerometer exceeds a preselected input voltage applied to the comparator.

8. The combination as claimed in claim 7, wherein said accelerometer is an integrated circuit containing a force sensor and means for converting the response of the sensor to said output voltage.

9. An in-car video surveillance system for a law enforcement vehicle, automatically activated in response to a collision, said system comprising:
an accelerometer having an axis of operation oriented to cause the accelerometer to be responsive to an impact,
circuitry responsive to said accelerometer for producing an output signal when said accelerometer senses a predetermined G force indicative of said impact,
a video camera for viewing a selected scene,
a controller for producing a record command in response to said output signal, and
a video recorder having a record mode initiated in response to said record command, whereby the video surveillance system records the incident responsible for the impact.

10. The in-car video surveillance system as claimed in claim 9, further comprising a video recording system including said video camera, said video recorder, said controller, and a history buffer responsive to said camera for continuously receiving data therefrom, and wherein said history buffer is responsive to said record command for transferring data in the buffer to the video recorder.

11. The in-car video surveillance system as claimed in claim 9, wherein said axis of operation of the accelerometer extends generally in the front to rear direction of movement of the vehicle, and wherein said system further comprises a second accelerometer having an axis of operation extending transversely of said direction of movement, and circuitry responsive to said second accelerometer for producing a second output signal when said second accelerometer senses a predetermined G force indicative of an impact, said controller being responsive to said second output signal for delivering said record command.

12. The in-car video surveillance system as claimed in claim 11, further comprising a video recording system including said video camera, said video recorder, said controller, and a history buffer responsive to said camera for continuously receiving data therefrom, and wherein said history buffer is responsive to said record command for transferring data in the buffer to the video recorder.
